(19) United States
(12) Patent Application Publication
(10) Pub. No.: US 2008/0101509 A1
(43) Pub. Date: May 1, 2008

(54) APPARATUS AND METHOD FOR DECODING RECEIVED SIGNAL IN MULTIPLE INPUT MULTIPLE OUTPUT (MIMO) SYSTEM

(75) Inventors: Hee-Goo HAN, Suwon-si (KR); Won-Suk Jung, Ansan-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/927,062

(22) Filed: Oct. 29, 2007

(30) Foreign Application Priority Data
Oct. 31, 2006 (KR) 2006-0106224

(51) Int. Cl. H04L 25/08; H04B 1/10

(52) U.S. Cl. 375/346

(57) ABSTRACT

Apparatus and method for decoding a received signal at a receiver of a MIMO system are provided. The method includes calculating an initial estimate value and an initial radius of transmit symbols from the received signal; determining whether to reduce the initial radius according to SNR of the received signal; selecting the initial radius, if it is determined not to reduce the initial radius, or the reduced radius, if it is determined to reduce the initial radius; and selecting a lattice point having a minimum Euclidean distance to the received signal from lattice points within a high-dimensional sphere of the selected radius.

### PRIORITY

This application claims priority under 35 U.S.C. § 119 to an application filed in the Korean Intellectual Property Office on Oct. 31, 2006 and assigned Serial No. 2006-106224, the contents of which are incorporated herein by reference.

### BACKGROUND OF THE INVENTION

1. Field of the Invention

The present invention relates generally to an apparatus and method for decoding a received signal in a Multiple Input Multiple Output (MIMO) system.

2. Description of the Related Art

In general, methods of detecting transmit symbols at a receiver in a Multiple Input Multiple Output (MIMO) system include a Maximum Likelihood (ML) detection method, a linear detection method, and a Vertical-Bell LAboratory Space Time (V-BLAST) method. The ML detection method selects a combination which maximizes a likelihood function from all possible transmit symbol combinations. The linear detection method utilizes an inverse function of a channel matrix and is classified into Zero Forcing (ZF) and Minimum Mean Square Error (MMSE). The V-BLAST method detects the transmit symbols one by one, eliminates the effect of the detected transmit symbols, and then redetects the transmit symbols. Of the transmit symbol detection methods, while the ML detection method exhibits the optimum detection performance, its complexity exponentially increases according to the modulation scheme and the number of transmit antennas. As a result, when a high-order modulation scheme is applied or the number of transmit antennas is great, it is almost impossible to apply the ML detection method to the actual system because of its high level of complexity.

To address this problem, a sphere decoding method was suggested as the transmit symbol detection method, which exhibits a similar performance to the ML method, but with reduced complexity. The sphere decoding method detects the transmit symbols by searching for lattice vectors only within a high-dimensional sphere of a specific radius from the received signal vector, rather than searching for all possible transmit symbols. A representative sphere coding method is Modified Schnorr-Euchner (MSE) method. However, the MSE is subject to the high decoding complexity as well because of its great sphere radius.

A sphere decoding method was suggested to mitigate the decoding complexity by decreasing the sphere radius and to exhibit the similar performance as the ML detection method. The following explanation describes a sphere decoder using Radius Reduction Control (RRC) method to detect transmit symbols by decreasing the sphere radius.

FIG. 1 illustrates operations of a conventional sphere decoder in a receiver of MIMO system.

The sphere decoder of the receiver of FIG. 1, upon receiving a signal on an antenna, detects an initial estimate value of transmit symbols from the received signal using a suboptimal method (e.g., ZF, MMSE, V-BLAST, and DFE) in step 101.

The sphere decoder sets in step 103 an initial radius of the high-dimensional sphere by measuring the Euclidean distance between the initial estimate value and the received signal, and decreases in step 105 the set initial radius using a sequential alternate search method.

In step 107, the sphere decoder searches for lattice vectors within the high-dimensional sphere of the reduced radius and selects in step 109 a lattice vector having a shortest Euclidean distance with the received signal from the searched lattice vectors. Next, the sphere decoder terminates the algorithm.

The above method for detecting the transmit symbols by re-reducing the initial radius determined using the initial estimate value can greatly decrease the number of the lattice vectors within the high-dimensional sphere by reducing the initial radius using the sequential alternate search. Therefore, the complexity of the decoder can be mitigated regardless of the search method of the lattice vectors. However, the initial radius reduction method requires the additional computation for the initial radius reduction. When the initially set radius is large enough, the initial radius reduction method does not greatly reduce the radius even through the radius reduction process. Consequently, the radius reduction is also subject to higher complexity.

### SUMMARY OF THE INVENTION

An aspect of the present invention is to substantially solve at least the above problems and/or disadvantages and to provide at least the advantages below. Accordingly, an aspect of the present invention is to provide an apparatus and method for decoding a received signal in a Multiple Input Multiple Output (MIMO) system.

Another aspect of the present invention is to provide an apparatus and method for decoding a received signal by controlling whether to reduce an initial radius according to a Signal-to-Noise Ratio (SNR) of the received signal at a receiver of MIMO system.

The above aspects are achieved by providing a method for decoding a received signal at a receiver of a MIMO system, which includes calculating an initial estimate value and an initial radius of transmit symbols from the received signal; determining whether to reduce the initial radius according to a SNR of the received signal; selecting the initial radius, if it is determined not to reduce the initial radius, or the reduced radius if it is determined to reduce the initial radius; and selecting a lattice point having a minimum Euclidean distance to the received signal from lattice points within a high-dimensional sphere of the selected radius.

According to one aspect of the present invention, an apparatus for decoding a received signal at a receiver of a MIMO system includes an initial estimate selector for calculating an initial estimate value of transmit symbols from the received signal; a radius reduction determiner for determining whether to reduce the initial radius according to SNR of the received signal; a radius selector for setting an initial radius by measuring a Euclidean distance between the received signal and the initial estimate value, and selecting the initial radius, if it is determined not to reduce the initial radius, or the reduced radius if it is determined to reduce the initial radius; and a vector selector for outputting a lattice point having a minimum Euclidean distance to the received signal from lattice points within a high-dimensional sphere of the selected radius.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates operations of a conventional sphere decoder in a receiver of MIMO system;

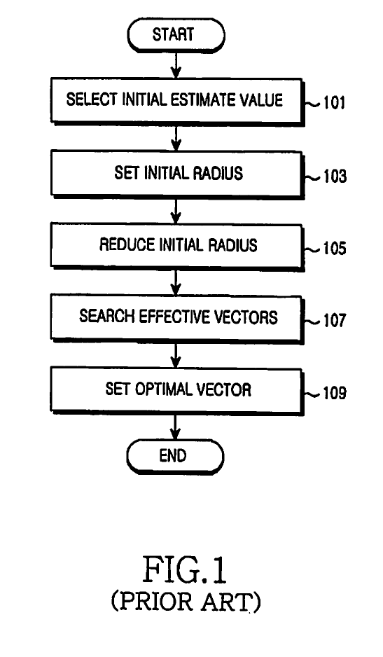

FIG. 2 is a block diagram of a sphere decoder in a receiver of MIMO system according to the present invention;

FIG. 3 illustrates operations of the sphere decoder in the receiver of the MIMO system according to the present invention;

FIGS. 4A and 4B show the decoding complexity measured when the conventional sphere decoder and the present sphere decoder uses 16 QAM constellation; and

FIGS. 5A and 5B show the decoding complexity measured when the conventional sphere decoder and the present sphere decoder uses 64 QAM constellation

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for decoding a received signal by determining whether to reduce an initial radius according to a Signal to Noise Ratio (SNR) of the received signal at a receiver of a Multiple Input Multiple Output (MIMO) system.

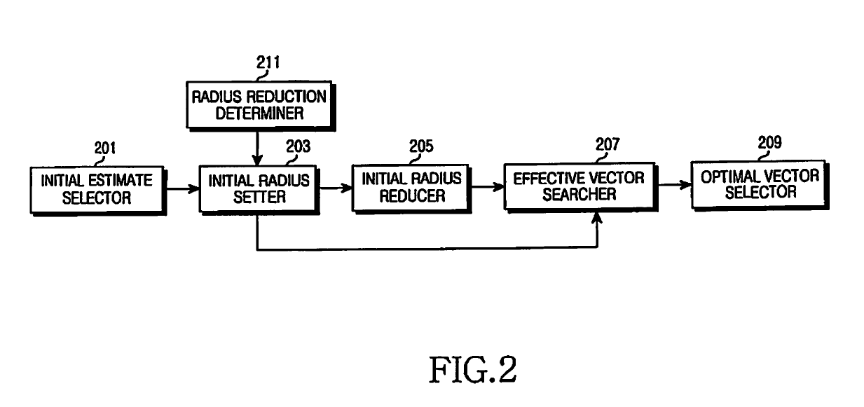

FIG. 2 is a block diagram of a sphere decoder in a receiver of MIMO system according to the present invention. The sphere decoder includes an initial estimate selector 201, an initial radius setter 203, an initial radius reducer 205, an effective vector searcher 207, an optimal vector selector 209, and a radius reduction determiner 211.

The initial estimate selector 201 detects an initial estimate value of transmit symbols from the received signal using a suboptimal method (e.g., ZF, MMSE, V-BLAST, and DFE), and outputs the received signal and the initial estimate value to the initial radius setter 203.

The initial radius setter 203 measures Euclidean distance, that is, a spatial distance between the initial estimate value and the received signal both received from the initial estimate selector 201, and sets the measured Euclidean distance to an initial radius for forming a high-dimensional sphere. According to a control signal from the radius reduction determiner 211, the initial radius setter 203 outputs the received signal and the initial radius to either the initial radius reducer 205 or the effective vector searcher 207. Specifically, when the control signal from the radius reduction determiner 211 directs a radius reduction, the initial radius setter 203 outputs the received signal and the initial radius to the initial radius reducer 205. When the control signal directs no radius reduction, the initial radius setter 203 outputs the received signal and the initial radius to the effective vector searcher 207.

Upon receiving the received signal and the initial radius from the initial radius setter 203, the initial radius reducer 205 reduces the initial radius using a sequential alternate search method based on Equation (1). In more detail, to reduce the initial radius, the initial radius reducer 205 selects one of a plurality of dimensions constituting the initial estimate values and fixes the initial estimate values corresponding to dimensions other than the selected dimension. Next, the initial radius reducer 205 assumes lattice points belonging to the selected dimension to the respective initial estimate values of the corresponding dimensions, computes the Euclidean distance between the assumed initial estimate values and the received signal, and sets the lattice point having the minimum Euclidean distance to the Euclidean distance of the corresponding dimension. The initial radius reducer 205 performs the same process with respect to the other dimensions to reset the initial estimate value of all of the dimensions. Therefore, the initial radius can be decreased.

Equation (1) expresses the initial radius reduction through the sequential alternate search with respect to a random dimension of the plurality of the dimensions constituting the initial estimate value.

$$( {\hat{x}}_{i}^{v} {r}^{v} ) = ( arg \begin{matrix}min \\ {x}_{i}^{v} ∈ {Z}_{q}^{( i )}\end{matrix} \sqrt{{‖ y - R \cdot {\hat{x}}^{( i )} ‖}^{2} + ‖ Z ‖} \cdot \sqrt{{‖ y - R \cdot {\hat{x}}^{v} ‖}^{2} + {‖ Z ‖}^{2}} ) \\ IF {r}^{v} < r , then ( r , \hat{x} ) = ( {r}^{v} , {\hat{x}}^{v} ) \qquad ( 1 )$$

In Equation (1), \hat{x} denotes the initial estimate value which is estimated using the suboptimal method, r denotes the radius, i denotes the selected dimension, q denotes root Q matrix, and Z denotes the set of the lattice points. The Q matrix and R matrix are acquired by the QRD(QR-Decomposition) of channel matrix H, y represents a matrix acquired by multiplication between the radius and a first column to a Nst column of Q matrix, and v means a selected value.

The effective vector searcher 207 receives the received signal and the radius from either the initial radius setter 203 or the initial radius reducer 205, and searches for lattice vectors within the high-dimensional sphere formed with the input radius based on the received signal. The effective vector searcher 207 can search for the effective vectors by excluding lattice vectors outside the range of the high-dimensional sphere while searching through the tree from the highest dimension to the lowest dimension. Under the control of the radius reduction determiner 211, the effective vector searcher 207 may receive the radius of the sphere to search for the effective lattice vectors from either the initial radius setter 203 or the initial radius reducer 205.

The optimal vector selector 209 receives the received signal and the discovered effective lattice vectors from the effective vector searcher 207, measures Euclidean distances between the effective lattice vectors and the received signal, and selects a lattice vector having the minimum Euclidean distance.

The radius reduction determiner 211 measures the Signal-to-Noise Ratio (SNR) of the received signal, determines whether to shrink the initial radius defined at the initial radius setter 203 by comparing the measured SNR with a preset threshold, and then issues a signal to the initial radius setter 203. When the measured SNR is less than the threshold (SNR<threshold), the radius reduction determiner 211 issues an initial radius reduction signal to the initial radius setter 203. When the measured SNR is greater than or equal to the threshold (SNR>threshold), the radius reduction determiner 211 issues an initial radius non-reduction signal to the initial radius setter 203. The threshold value can be acquired from experimentation.

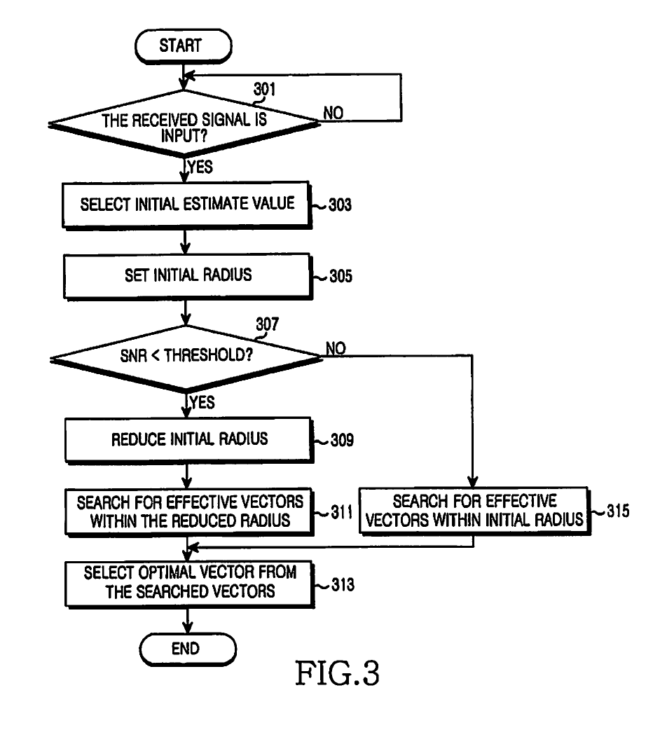

FIG. 3 illustrates operations of the sphere decoder in the receiver of the MIMO system according to the present invention.

In FIG. 3, the sphere decoder detects if the received signal on the antenna is input to the sphere decoder in step 301. When the received signal is input, the sphere decoder detects the initial estimate value of the transmit symbols from the received signal using the suboptimal method in step 303. In step 305, the sphere decoder measures the Euclidean distance between the received signal and the initial estimate value and sets the measured Euclidean distance to the radius of the high-dimensional sphere.

In step 307, the sphere decoder measures the SNR of the received signal and compares the measured SNR with the preset threshold.

When the measured SNR is less than the threshold, the sphere decoder determines that the set initial radius is large enough and reduces the set initial radius in step 309. The sphere decoder shrinks the initial radius set in step 305, using the sequential alternate search method expressed by Equation (1).

Next, the sphere decoder searches for effective lattice vectors within the high-dimensional sphere having the reduced radius in step 311. In step 313, the sphere decoder selects a lattice vector having the minimum Euclidean distance to the received signal from the searched effective lattice vectors. The sphere decoder then terminates the process.

By contrast, when the measured SNR is greater than or equal to the threshold, the sphere decoder does not shrink the initial radius by determining that the set initial radius is small enough and searches for lattice vectors within the high-dimensional sphere of the initial radius in step 315. Next, the sphere decoder selects a lattice vector having the minimum Euclidean distance to the received signal from the searched lattice vectors in step 313 and then terminates the process.

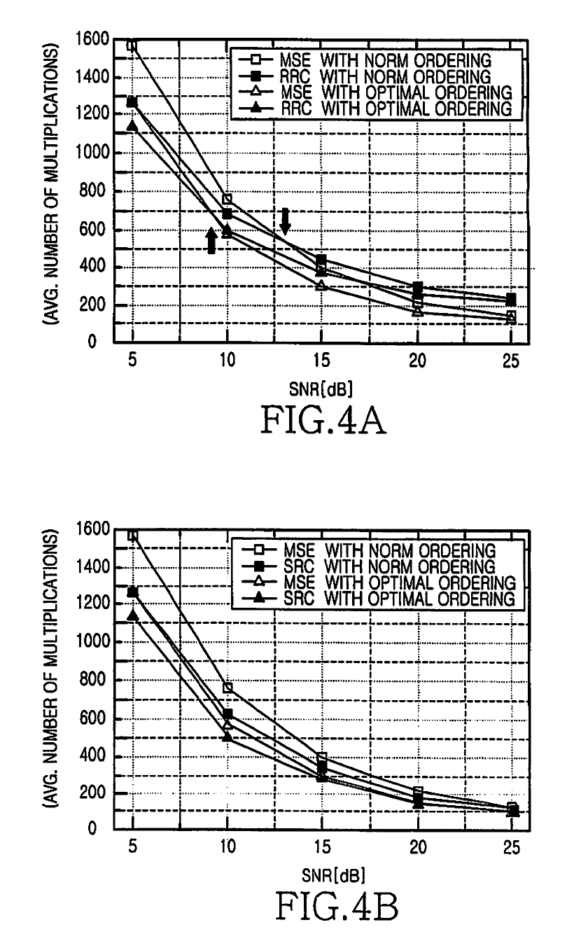

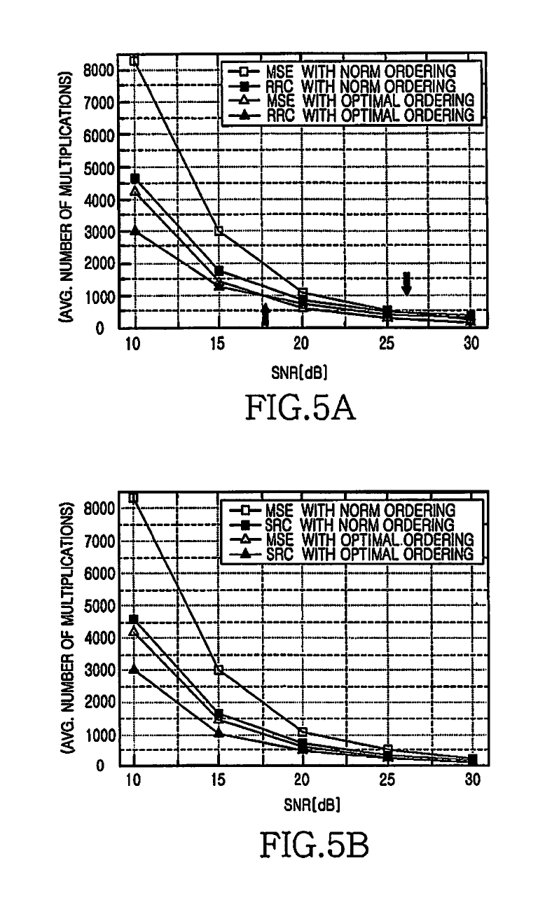

The decoding complexity of the sphere decoder of FIGS. 2 and 3 will further be explained with reference to FIGS. 4A, 4B, 5A and 5B.

FIGS. 4A, 4B, 5A and 5B show the decoding complexity measured when the conventional sphere decoder and the present sphere decoder uses 16 QAM and 64 QAM constellations. The horizontal axis indicates the SNR, and the vertical axis indicates the complexity according to the number of multiplications of the sphere decoder.

FIGS. 4A and 5A show the decoding complexity according to the ordering (norm ordering and optimal ordering) when the sphere decoder uses the conventional MSE method and the RRC method for reducing the initial radius. FIGS. 4B and 5B show the decoding complexity when the sphere decoder uses the MSE method and the Smart Radius Control (SRC) method for determining whether to shrink the initial radius based on the SNR. Particularly, the threshold of FIG. 4B utilizes norm ordering: 10 dB and optimal ordering: 5 dB experimentally obtained in the MIMO system using 16 QAM constellation. The threshold of FIG. 5B utilizes norm ordering: 13 dB and optimal ordering: 11 dB experimentally obtained in the MIMO system using 64 QAM constellation.

As shown in FIGS. 4A and 5A, when the SNR of the received signal is sufficiently low, the RRC method has the lower complexity than the MSE method. When the SNR of the received signal is higher than a certain SNR, the RRC method is subject to the higher complexity than the MSE method.

By contrast, the SRC method for determining whether to reduce the initial radius based on the SNR constantly exhibits the lower complexity than the MSE method regardless of the SNR of the received signal as shown in FIGS. 4B and 5B.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

As set forth above, the receiver of the MIMO system decodes the received signal by determining whether to shrink the initial radius according to the SNR of the received signal. The initial radius is reduced only when the initial radius is set large enough because of the hostile channel conditions. Therefore, the lower complexity than the complexity of the conventional sphere decoding method (MSE method) can be constantly attained and the same detecting performance can be acquired.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for decoding a received signal at a receiver of a Multiple Input Multiple Output (MIMO) system, the method comprising:
calculating an initial estimate value and an initial radius of transmit symbols from the received signal;
determining whether to reduce the initial radius according to a Signal to Noise Ratio (SNR) of the received signal;
selecting the initial radius, if it is determined not to reduce the initial radius, or the reduced radius, if it is determined to reduce the initial radius; and
selecting a lattice point having a minimum Euclidean distance to the received signal from lattice points within a high-dimensional sphere of the selected radius.

2. The method of claim 1, wherein the step of determining whether to reduce the initial radius comprises:
determining to reduce the initial radius when the SNR is less than a preset threshold, and determining not to reduce the initial radius when the SNR is greater than or equal to the threshold.

3. The method of claim 1, wherein the step of selecting the initial radius or the reduced radius comprises:
reducing the initial radius using the initial estimate value when it is determined to reduce the initial radius; and
selecting the reduced radius as a radius of the high-dimensional sphere.

4. The method of claim 1, wherein the step of selecting the initial radius or the reduced radius comprises:
selecting the initial radius as a radius of the high-dimensional sphere when it is determined not to reduce the initial radius.

5. An apparatus for decoding a received signal at a receiver of a Multiple Input Multiple Output (MIMO) system, comprising:
an initial estimate selector for calculating an initial estimate value of transmit symbols from the received signal;
a radius reduction determiner for determining whether to reduce the initial radius according to a Signal to Noise Ratio (SNR) of the received signal;
a radius selector for setting an initial radius by measuring a Euclidean distance between the received signal and the initial estimate value, and selecting the initial radius, if it is determined not to reduce the initial radius, or the reduced radius, if it is determined to reduce the initial radius; and
a vector selector for outputting a lattice point having a minimum Euclidean distance to the received signal from lattice points within a high-dimensional sphere of the selected radius.

6. The apparatus of claim 5, wherein the radius reduction determiner determines to reduce the initial radius when the SNR is less than a threshold, and determines not to reduce the initial radius when the SNR is greater than or equal to the threshold.

7. The apparatus of claim 5, wherein the radius selector selects and outputs the initial radius as a radius of the high-dimensional sphere to the vector selector when it is determined not to reduce of the initial radius at the radius reduction determiner, and the radius selector reduces the initial radius and outputs the reduced radius to the vector selector when it is determined to reduce the initial radius.

8. The apparatus of claim 7, wherein the radius selector comprises:
an initial radius reducer for reducing the initial radius using the initial estimate value.

9. A method for decoding a received signal at a receiver of a Multiple Input Multiple Output (MIMO) system, the method comprising:
calculating an initial estimate value and an initial radius of transmit symbols from the received signal;
determining whether to reduce the initial radius according to a Signal to Noise Ratio (SNR) of the received signal;
selecting the initial radius, if it is determined not to reduce the initial radius, or the reduced radius, if it is determined to reduce the initial radius; and
selecting a lattice point using of the selected radius.

10. A Multiple Input Multiple Output (MIMO) system for decoding a received signal, comprising:
means for calculating an initial estimate value and an initial radius of transmit symbols from the received signal;
means for determining whether to reduce the initial radius according to a Signal to Noise Ratio (SNR) of the received signal;
means for selecting the initial radius, if it is determined not to reduce the initial radius, or the reduced radius, if it is determined to reduce the initial radius; and
means for selecting a lattice point using of the selected radius.

11. A computer-readable recording medium having recorded thereon a program for decoding a received signal at a receiver of a Multiple Input Multiple Output (MIMO) system, comprising:
a first code segment, for calculating an initial estimate value and an initial radius of transmit symbols from the received signal;
a second code segment, for determining whether to reduce the initial radius according to a Signal to Noise Ratio (SNR) of the received signal;
a third segment, for selecting the initial radius, if it is determined not to reduce the initial radius, or the reduced radius, if it is determined to reduce the initial radius; and
a fourth segment, for selecting a lattice point using of the selected radius.
